(19) United States
(12) Patent Application Publication
(10) Pub. No.: US 2008/0291835 A1
(43) Pub. Date: Nov. 27, 2008

(54) METHOD AND APPARATUS FOR MANAGING BUFFERS FOR TRANSMITTING PACKETS

(76) Inventors: Omar Cardona, Austin, TX (US); James Brian Cunningham, Austin, TX (US); Baltazar De Leon, III, Austin, TX (US); Paul Nguyen, Austin, TX (US)

Correspondence Address: IBM CORP (YA);C/O YEE & ASSOCIATES PC, P.O. BOX 802333, DALLAS, TX, 75380, US

(21) Appl. No.: 11/751,323

(22) Filed: May 21, 2007

(51) Int. Cl. G06F 11/00; H04L 12/56

(52) U.S. Cl. 370/241; 370/412

(57) ABSTRACT

A computer implemented method, apparatus, and computer usable program code for managing buffers. A number of buffers present in a pool of buffers assigned to a network device driver are monitored, wherein the buffers in the pool of buffers are used to process packets of data for transmission onto a network. A request is denied from a transport layer for a buffer from the pool of buffers if the number of buffers falls below a threshold level, wherein at least one buffer is present in a buffer pool if the number of buffers falls below the threshold level.

### BACKGROUND OF THE INVENTION

1. Field of the Invention

The present invention relates generally to an improved data processing system and in particular to a method and apparatus for processing data. Still more particularly, the present invention relates to a computer implemented method, apparatus, and computer usable program code for managing buffers used to transmit packets on a network.

2. Description of the Related Art

Computers and other devices on a network, such as a local area network or the Internet, often exchange data with other computers or devices. For example, a word processing application may retrieve a document from a storage device located on another computer or save a document onto a storage device on another computer. A browser application may send information, such as a request for a web page. In response to the request, the browser application may receive a web page from a website located on a server computer. Further, the browser application may send information, such as data entered into a form on a downloaded web page to a server. All of these different types of data transmissions are accomplished by sending data across a network connection using discrete segments of data. The data sent onto a network is referred to as a packet.

Operating systems typically include a network protocol stack that is used to transmit data received by an application for transmission onto a network. This data is typically received in the form of a set of memory locations, such as a set of buffers in the memory of a computer.

The networking protocol in the AIX® operating system currently implements interface specific network buffers. AIX® is a registered trademark of International Business Machines Corporation. These types of buffers may be used to improve the performance or speed at which data is transmitted by a networking protocol stack onto the network.

Performance gains are obtained because a network device driver does not have to copy a packet for transmission to pre-registered transmit buffers. As a result, the overhead of a copy operation needed to place data received from an application into pre-registered transmit buffers is avoided. In some cases, the network device driver does not have to perform an on-the-fly or dynamic registration of a transmit buffer containing a packet for transmission. This situation results in avoiding a series of system calls that require time in terms of processor cycles and/or completion time.

These types of buffers are obtained from a pool of buffers that are associated or belong to an interface, such as a network device driver. This pool of buffers is limited when an interface specific network buffer is used to transmit data. This buffer is passed to the transmission control protocol stack in the transport layer. This stack keeps track of the buffer and does not decrement a count of buffers until an acknowledgement of the receipt of the data in the buffer is received.

In other words, the buffer is not released for other use until the packet or the portion of the packet in the buffer has been acknowledged as being received by the destination. As a result, in some cases, long lived connections may result in a depletion of buffers that are available in the buffer pool. This type of situation may occur if long lived connections are present between the transmission and acknowledgement of the packet. If the device driver has no pre-buffers in its buffer pool to use, all other transmission operations will halt until a free buffer becomes available.

### SUMMARY OF THE INVENTION

The illustrative embodiments provide a computer implemented method, apparatus, and computer usable program code for managing buffers. A number of buffers present in a pool of buffers assigned to a network device driver are monitored, wherein the buffers in the pool of buffers are used to process packets of data for transmission onto a network. A request is denied from a transport layer for a buffer from the pool of buffers if the number of buffers falls below a threshold level, wherein at least one buffer is present in a buffer pool if the number of buffers falls below the threshold level.

### BRIEF DESCRIPTION OF THE DRAWINGS

The novel features believed characteristic of the invention are set forth in the appended claims. The invention itself, however, as well as a preferred mode of use, further objectives and advantages thereof, will best be understood by reference to the following detailed description of an illustrative embodiment when read in conjunction with the accompanying drawings, wherein:

FIG. 1 is a block diagram of a data processing system in which illustrative embodiments may be implemented;

FIG. 2 is a diagram of a transmission control protocol/Internet protocol (TCP/IP) and similar protocols in accordance with an illustrative embodiment of the present invention;

FIG. 3 is a diagram illustrating components used for managing buffers in accordance with an illustrative embodiment;

FIG. 4 is a flowchart of a process for managing requests for buffers in accordance with an illustrative embodiment; and

FIG. 5 is a flowchart of a process for determining whether a buffer can be supplied in response to a request for a buffer in accordance with an illustrative embodiment.

### DETAILED DESCRIPTION OF THE PREFERRED EMBODIMENT

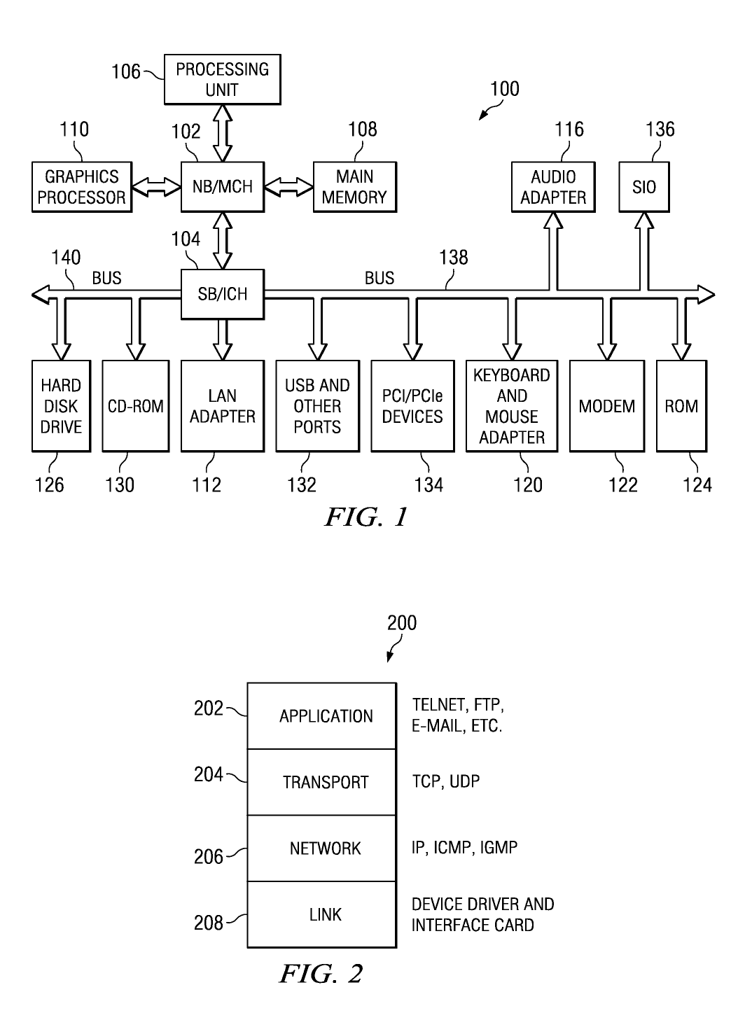

With reference now to the figures and in particular with reference to FIG. 1, a block diagram of a data processing system is depicted in which illustrative embodiments may be implemented. Data processing system 100 is an example of a computer in which code or instructions implementing the processes of the illustrative embodiments may be located.

In the depicted example, data processing system 100 employs a hub architecture including a north bridge and memory controller hub (NB/MCH) 102 and a south bridge and input/output (I/O) controller hub (SB/ICH) 104. Processing unit 106, main memory 108, and graphics processor 110 are coupled to north bridge and memory controller hub 102. Processing unit 106 may contain one or more processors and even may be implemented using one or more heterogeneous processor systems. Graphics processor 110 may be coupled to the NB/MCH through an accelerated graphics port (AGP), for example.

In the depicted example, local area network (LAN) adapter 112 is coupled to south bridge and I/O controller hub 104, audio adapter 116, keyboard and mouse adapter 120, modem 122, read only memory (ROM) 124, universal serial bus (USB) and other ports 132. PCI/PCIe devices 134 are coupled to south bridge and I/O controller hub 104 through bus 138. Hard disk drive (HDD) 126 and CD-ROM 130 are coupled to south bridge and I/O controller hub 104 through bus 140.

PCI/PCIe devices may include, for example, Ethernet adapters, add-in cards, and PC cards for notebook computers. PCI uses a card bus controller, while PCIe does not. ROM 124 may be, for example, a flash binary input/output system (BIOS). Hard disk drive 126 and CD-ROM 130 may use, for example, an integrated drive electronics (IDE) or serial advanced technology attachment (SATA) interface. A super I/O (SIO) device 136 may be coupled to south bridge and I/O controller hub 104.

An operating system runs on processing unit 106. This operating system coordinates and controls various components within data processing system 100 in FIG. 1. The operating system may be a commercially available operating system, such as Microsoft® Windows XP®. (Microsoft® and Windows XP® are trademarks of Microsoft Corporation in the United States, other countries, or both). An object oriented programming system, such as the Java™ programming system, may run in conjunction with the operating system and provides calls to the operating system from Java™ programs or applications executing on data processing system 100. Java™ and all Java™-based trademarks are trademarks of Sun Microsystems, Inc. in the United States, other countries, or both.

Instructions for the operating system, the object-oriented programming system, and applications or programs are located on storage devices, such as hard disk drive 126. These instructions and may be loaded into main memory 108 for execution by processing unit 106. The processes of the illustrative embodiments may be performed by processing unit 106 using computer implemented instructions, which may be located in a memory. An example of a memory is main memory 108, read only memory 124, or in one or more peripheral devices.

The hardware shown in FIG. 1 may vary depending on the implementation of the illustrated embodiments. Other internal hardware or peripheral devices, such as flash memory, equivalent non-volatile memory, or optical disk drives and the like, may be used in addition to or in place of the hardware depicted in FIG. 1. Additionally, the processes of the illustrative embodiments may be applied to a multiprocessor data processing system.

The systems and components shown in FIG. 1 can be varied from the illustrative examples shown. In some illustrative examples, data processing system 100 may be a personal digital assistant (PDA). A personal digital assistant generally is configured with flash memory to provide a non-volatile memory for storing operating system files and/or user-generated data. Additionally, data processing system 100 can be a tablet computer, laptop computer, or telephone device.

Other components shown in FIG. 1 can be varied from the illustrative examples shown. For example, a bus system may be comprised of one or more buses, such as a system bus, an I/O bus, and a PCI bus. Of course the bus system may be implemented using any suitable type of communications fabric or architecture that provides for a transfer of data between different components or devices attached to the fabric or architecture. Additionally, a communications unit may include one or more devices used to transmit and receive data, such as a modem or a network adapter. Further, a memory may be, for example, main memory 108 or a cache such as found in north bridge and memory controller hub 102. Also, a processing unit may include one or more processors or CPUs.

The depicted examples in FIG. 1 are not meant to imply architectural limitations. In addition, the illustrative embodiments provide for a computer implemented method, apparatus, and computer usable program code for compiling source code and for executing code. The methods described with respect to the depicted embodiments may be performed in a data processing system, such as data processing system 100 shown in FIG. 1.

The different illustrative embodiments provide a computer implemented method, apparatus, and computer usable program code for managing buffers. A number of buffers present in a pool of buffers assigned to a network device driver is monitored. The buffers in the pool of buffers are used to process packets of data for transmission onto a network. Requests from a transport layer for a buffer from the pool of buffers are denied if the number of buffers falls below a threshold level. The buffer may be provided to the transport layer if the number of buffers in the buffer pool exceeds a second threshold level after the number of buffers falls below the first threshold level. The use of these two threshold levels avoids having requests being denied and granted in a back and forth fashion if the number of buffers changes above and below the threshold by one.

In another illustrative embodiment, a single threshold level may be used in which requests are again granted for a buffer if the number of buffers in the buffer pool equals or exceeds the threshold level in these examples.

Next, turning now to FIG. 2, a diagram of a transmission control protocol/Internet protocol (TCP/IP) and similar protocols is depicted in accordance with an illustrative embodiment. TCP/IP and similar protocols are utilized by communications architecture 200. In this example, communications architecture 200 is a 4-layer system. This architecture includes application layer 202, transport layer 204, network layer 206, and link layer 208. Each layer is responsible for handling various communications tasks. Link layer 208 also is referred to as the data-link layer or the network interface layer and normally includes the device driver in the operating system and the corresponding network interface card in the computer. This layer handles all the hardware details of physically interfacing with the network media being used, such as optical cables or Ethernet cables.

Network layer 206 also is referred to as the Internet layer and handles the movement of packets of data around the network. For example, network layer 206 handles the routing of various packets of data that are transferred over the network. Network layer 206 in the TCP/IP suite is comprised of several protocols, including Internet protocol (IP), Internet control message protocol (ICMP), and Internet group management protocol (IGMP).

Next, transport layer 204 provides an interface between network layer 206 and application layer 202 that facilitates the transfer of data between two host computers. Transport layer 204 is concerned with things such as, for example, dividing the data passed to it from the application into appropriately sized chunks for the network layer below, acknowledging received packets, and setting timeouts to make certain the other end acknowledges packets that are sent. In the TCP/IP protocol suite, two distinctly different transport protocols are present, Transport Control Protocol (TCP) and User Datagram Protocol (UDP). TCP provides reliability services to ensure that data is properly transmitted between two hosts, including dropout detection and retransmission services.

Conversely, UDP provides a much simpler service to the application layer by merely sending packets of data called datagrams from one host to the other, without providing any mechanism for guaranteeing that the data is properly transferred. When using UDP, the application layer must perform the reliability functionality.

Application layer 202 handles the details of the particular application. Many common TCP/IP applications are present for almost every implementation, including a Telnet for remote login; a file transfer protocol (FTP); a simple mail transfer protocol (SMTP) for electronic mail; and a simple network management protocol (SNMP). The mechanism of the present invention may be more specifically implemented in a layer, such as link layer 208.

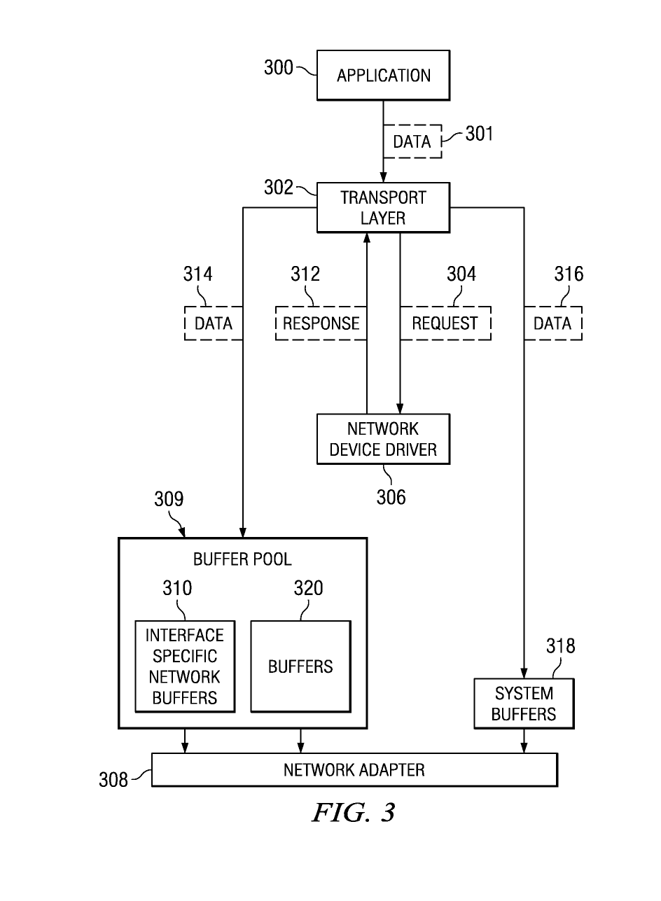

Turning now to FIG. 3, a diagram illustrating components used for managing buffers is depicted in accordance with an illustrative embodiment. In this example, application 300 may write data to a location that is remote to the data processing system on which application 300 executes. Application 300 writes data 301 to a socket in transport layer 302. In response to receiving a request to write data 301, a transport protocol layer within transport layer 302 sends request 304 to network device driver 306 for a buffer for use in placing data for a packet for transmission by network adapter 308.

Network device driver 306 may segregate or pass up interface specific network buffers 310 from buffer pool 309. These buffers are called interface specific network buffers 310 when they are given to transport layer 302. Access to interface specific network buffers 310 is provided to transport layer 302 through response 312. As a result, transport layer 302 writes data 314 into interface specific network buffers 310. Data 314 is for transmission in a packet and may use one or more interface specific network buffers 310.

Interface specific network buffers 310 are buffers that are assigned to network device driver 306. These buffers are already pre-registered for access by network adapter 308. If sufficient buffers within buffer pool 309 are not present, network device driver 306 denies the request in response 312. Currently, this occurs when all of the buffers in buffer pool 309 have been used up as interface specific network buffers 310 by transport layer 302.

In the illustrative embodiments, network device driver 306 monitors the number of buffers in buffer pool 309. If the number of buffers falls below a first or lower threshold level, network device driver 306 then denies request 304 in response 312. In this manner, some buffers in buffer pool 309 may always be available for use by network device driver 306 to send data to network adapter 308 for transport onto the network.

In this situation, transport layer 302 writes data 316 into system buffers 318. System buffers 318 are not accessible by network adapter 308. System buffers 318 are passed to network device driver 306 for processing.

Network device driver 306 may copy data 316 from system buffers 318 into one or more buffers 320 within buffer pool 309. These buffers are accessible by network adapter 308. Alternatively, network device driver 306 may register system buffers 318 to make system buffers 318 accessible by network adapter 308.

Thus, the different illustrative embodiments use a threshold level to ensure that interface specific network buffers 310 and buffers 320 are not used up such that network device driver 306 has no buffers available to send data onto the network through network adapter 308. If interface specific network buffers 310 are passed to transport layer 302 in the manner that no buffers are left in buffers 320 within buffer pool 309, a situation may arise in which the length of different transport control protocol connections may result in no buffers being available within buffer pool 309. As a result, data transfer for other requests halts and is unable to resume until buffers are freed up.

In these examples, a buffer is an interface specific network buffer within interface specific network buffers 310 when that buffer has been passed to transport layer 302 for use. In this instance, the transport control protocol stack within transport layer 302 tracks these buffers and does not release them until an acknowledgement of the receipt of data by the target has occurred.

Network device driver 306 may continue to use buffers 320 to send data onto network adapter 308. Buffers 320 are not passed to transport layer 302. As a result, network device driver 306 may reuse those buffers without waiting for an acknowledgement from the target of the packets. By using a large threshold level, network device driver 306 is ensured to have some number of buffers in buffers 320 to copy data from system buffers 318 when request for interface specific network buffers 310 are denied as a result of the number of buffers in buffers 320 fall below the threshold level.

In these depicted examples, buffers are not provided to transport layer 302 until the number of buffers exceeds the threshold level. In these particular examples, a second threshold level is used to determine when buffers from buffers 320 will again be provided to transport layer 302.

The second threshold level is used to avoid a situation in which requests are denied when the number of buffers falls below the threshold level by a few buffers and then the number of buffers increases to just over the threshold level. At that point, buffers are again provided in response to request for transport layer 302. The request may then again drop the number of buffers below the threshold level. This type of situation may occur such that requests are granted, later denied, and then granted again. The upper threshold level avoids this type of situation. Setting the lower threshold level may be set by user or through some default level.

Further, the threshold levels may be set based on a dynamic analysis of usage of buffers by network device driver 306. In these illustrative examples, the threshold level is set based on the time needed by an adapter, such as network adapter 308, to process and send data in a buffer.

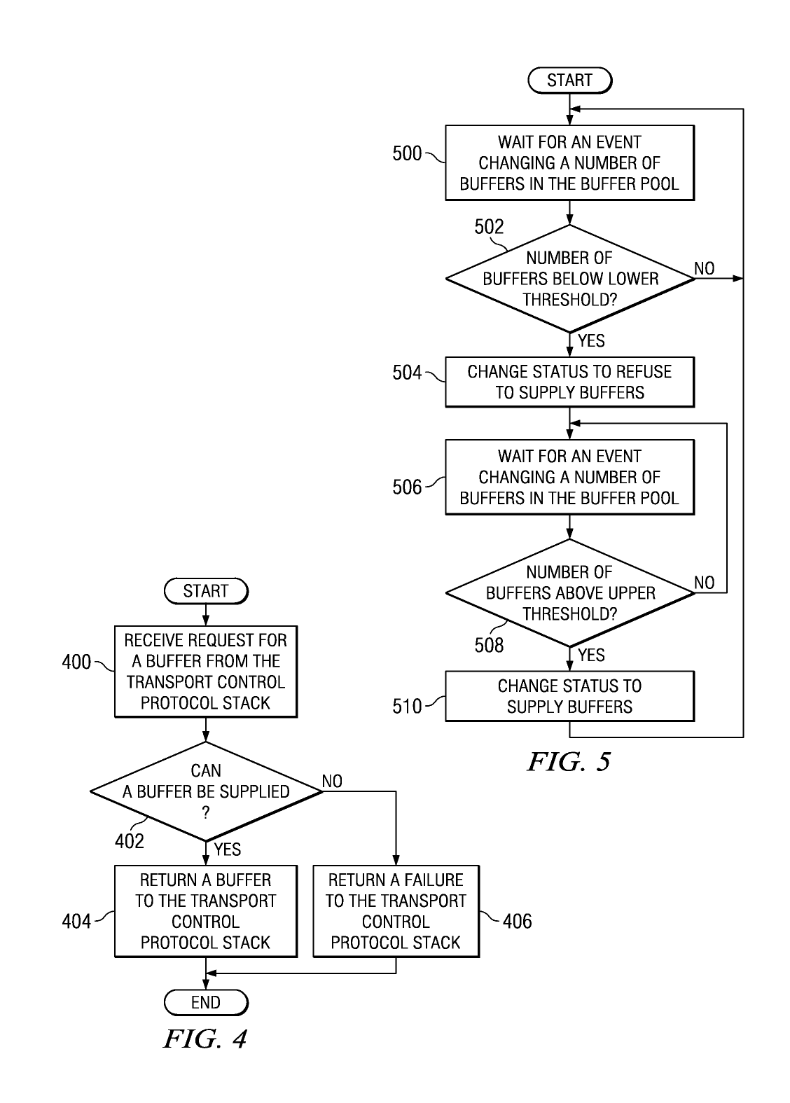

Turning now to FIG. 4, a flowchart of a process for managing requests for buffers is depicted in accordance with illustrative embodiment. The process illustrated in FIG. 4 may be implemented in an interface, such as network device driver 306 in FIG. 3.

Network device driver 306 in FIG. 3 is located in a link layer, such as link layer 208 in FIG. 2. Transport layer 302 in FIG. 3 is an example of transport layer 204 in FIG. 2.

The process begins by receiving a request from a buffer from a transport control protocol stack (step 400). The transport protocol stack, in these examples, is in a transport layer, such as transport layer 302 in FIG. 3. Next, a determination is made as to whether a buffer can be supplied (step 402). This determination is made by determining whether the number of buffers available for use is above a threshold level. A buffer is available for use if the buffer has not been passed up to the transport layer as an interface specific network buffer. In other cases, a buffer also available for use may include buffers that have not been used by the network device driver to copy data from system buffers.

If the buffer can be supplied, a buffer is returned to the transport control protocol stacks (step 404) with the process terminating thereafter. In these examples, the buffer is returned by providing a pointer to the buffer and a response, such as response 312 in FIG. 3.

With reference again to step 402, if a buffer cannot be supplied, a failure is returned to the transport control protocol stack (step 406). This failure may be, for example, an error code. The process also terminates after this step.

Turning now to FIG. 5, a flowchart of a process for determining whether a buffer can be supplied in response to a request for a buffer is depicted in accordance with an illustrative embodiment. The process illustrated in FIG. 5 is a more detailed description of step 402 in FIG. 4.

The process begins by waiting for an event changing the number of buffers in the buffer pool (step 500). In these examples, the event is the passing of a buffer from the buffer pool to a transport layer for use as an interface specific network buffer. Depending on the particular implementation, this event also may include the use of the buffer by a network device driver. For example, the use of a buffer may occur when the network device driver copies data from a system buffer to a buffer in its buffer pool. The event also includes the return of a buffer to the buffer pool after the data has been processed and the buffer is no longer retained by the transport layer.

Next, a determination is made as to whether the number of buffers in the buffer pool is below a low threshold level (step 502). If the number of buffers is not below the low threshold level, the process returns to step 500.

Otherwise, the process changes the status to refuse to supply buffers (step 504). The process then waits for an event changing the number of buffers in the buffer pool (step 506). If such an event occurs, a determination is now made as to whether the number of buffers is above the upper threshold level (step 508). If the number of buffers is not above the upper threshold level, the process returns to step 506. Otherwise, the process changes the status to supply buffers (step 510) with the process then returning to step 500 as described above.

This determination of whether buffers can be supplied is an example of the process used in one embodiment. In other embodiments, a single threshold may be used rather than two threshold levels.

The flowcharts and block diagrams in the different depicted embodiments illustrate the architecture, functionality, and operation of some possible implementations of apparatus, methods and computer program products. In this regard, each block in the flowchart or block diagrams may represent a module, segment, or portion of code, which comprises one or more executable instructions for implementing the specified function or functions. In some alternative implementations, the function or functions noted in the block may occur out of the order noted in the figures. For example, in some cases, two blocks shown in succession may be executed substantially concurrently, or the blocks may sometimes be executed in the reverse order, depending upon the functionality involved.

Thus, the different illustrative embodiments provide a computer implemented method, apparatus, and computer usable program code for managing buffers. A number of buffers present in a pool of buffers assigned to a network device driver is monitored. The buffers in the buffer pool are used to process packets of data for transmission onto a network. Requests from a transport layer for a buffer from a buffer pool is denied if the number of buffers falls below a threshold level. At least one buffer is still present in the buffer pool if the number of buffers falls below the threshold level.

In this manner, the different illustrative embodiments provide an ability to maintain at least one buffer in a buffer pool for use by an interface that sends data to a network adapter for transmission onto a network. By maintaining at least one buffer, the interface may copy data from a system buffer into that buffer for use. As a result, the interface does not have to wait for the transport layer to release an interface specific network buffer. As a result, situations in which data cannot be transmitted are avoided when interface specific network buffers are not released because a target has not yet acknowledged receipt of data in the data packet associated with the buffer. Further, this also avoids other delays in returning an interface specific network packet due to other situations or delays in the transport layer.

The invention can take the form of an entirely hardware embodiment, an entirely software embodiment or an embodiment containing both hardware and software elements. In a preferred embodiment, the invention is implemented in software, which includes but is not limited to firmware, resident software, microcode, etc.

Furthermore, the invention can take the form of a computer program product accessible from a computer-usable or computer-readable medium providing program code for use by or in connection with a computer or any instruction execution system. For the purposes of this description, a computer-usable or computer readable medium can be any tangible apparatus that can contain, store, communicate, propagate, or transport the program for use by or in connection with the instruction execution system, apparatus, or device.

The medium can be an electronic, magnetic, optical, electromagnetic, infrared, or semiconductor system (or apparatus or device) or a propagation medium. Examples of a computer-readable medium include a semiconductor or solid state memory, magnetic tape, a removable computer diskette, a random access memory (RAM), a read-only memory (ROM), a rigid magnetic disk and an optical disk. Current examples of optical disks include compact disk-read only memory (CD-ROM), compact disk-read/write (CD-R/W) and DVD.

Further, a computer storage medium may contain or store a computer readable program code such that when the computer readable program code is executed on a computer, the execution of this computer readable program code causes the computer to transmit another computer readable program code over a communications link. This communications link may use a medium that is, for example without limitation, physical or wireless.

A data processing system suitable for storing and/or executing program code will include at least one processor coupled directly or indirectly to memory elements through a system bus. The memory elements can include local memory employed during actual execution of the program code, bulk storage, and cache memories which provide temporary storage of at least some program code in order to reduce the number of times code must be retrieved from bulk storage during execution.

Input/output or I/O devices (including but not limited to keyboards, displays, pointing devices, etc.) can be coupled to the system either directly or through intervening I/O controllers.

Network adapters may also be coupled to the system to enable the data processing system to become coupled to other data processing systems or remote printers or storage devices through intervening private or public networks. Modems, cable modem and Ethernet cards are just a few of the currently available types of network adapters.

The description of the present invention has been presented for purposes of illustration and description, and is not intended to be exhaustive or limited to the invention in the form disclosed. Many modifications and variations will be apparent to those of ordinary skill in the art. The embodiment was chosen and described in order to best explain the principles of the invention, the practical application, and to enable others of ordinary skill in the art to understand the invention for various embodiments with various modifications as are suited to the particular use contemplated.

What is claimed is:

1. A computer implemented method for managing buffers, the computer implemented method comprising:
monitoring a number of buffers present in a pool of buffers assigned to a network device driver, wherein buffers in the pool of buffers are used to process packets of data for transmission onto a network; and
denying a request from a transport layer for a buffer from the pool of buffers if the number of buffers falls below a threshold level, wherein at least one buffer is present in a buffer pool if the number of buffers falls below the threshold level.

2. The computer implemented method of claim 1, wherein the threshold level is a first threshold level and further comprising:
providing the buffer to the transport layer if the number of buffers in the buffer pool exceeds a second threshold level after the number of buffers falls below the first threshold level.

3. The computer implemented method of claim 2 further comprising:
providing the buffer to the transport layer if the number of buffers in the buffer pool exceeds the first threshold level.

4. The computer implemented method of claim 1 further comprising:
receiving the request from a transport control protocol stack in a control layer for the buffer.

5. The computer implemented method of claim 1 further comprising:
supplying the transport layer a particular buffer that is not in the pool of buffers.

6. The computer implemented method of claim 5, wherein the particular buffer is a system buffer.

7. The computer implemented method of claim 1, wherein the buffer pool is a pool of mbufs.

8. A computer program product comprising:
a computer usable medium having computer usable program code for managing buffers, the computer program product comprising:
computer usable program code for monitoring a number of buffers present in a pool of buffers assigned to a network device driver, wherein buffers in the pool of buffers are used to process packets of data for transmission onto a network; and
computer usable program code for denying a request from a transport layer for a buffer from the pool of buffers if the number of buffers falls below a threshold level, wherein at least one buffer is present in a buffer pool if the number of buffers falls below the threshold level.

9. The computer program product of claim 8, wherein the threshold level is a first threshold level and further comprising:
computer usable program code for providing the buffer to the transport layer if the number of buffers in the buffer pool exceeds a second threshold level after the number of buffers falls below the first threshold level.

10. The computer program product of claim 9 further comprising:
computer usable program code for providing the buffer to the transport layer if the number of buffers in the buffer pool exceeds the first threshold level.

11. The computer program product of claim 8 further comprising:
computer usable program code for receiving the request from a transport control protocol stack in a control layer for the buffer.

12. The computer program product of claim 8 further comprising:
computer usable program code for supplying the transport layer a particular buffer that is not in the pool of buffers.

13. The computer program product of claim 12, wherein the particular buffer is a system buffer.

14. The computer program product of claim 8, wherein the buffer pool is a pool of mbufs.

15. A data processing system comprising:
a bus;
a communications unit connected to the bus;
a storage device connected to the bus, wherein the storage device includes computer usable program code; and
a processor unit connected to the bus, wherein the processor unit executes the computer usable program code to monitor a number of buffers present in a pool of buffers assigned to a network device driver, wherein buffers in the pool of buffers are used to process packets of data for transmission onto a network, and deny a request from a transport layer for a buffer from the pool of buffers if the number of buffers falls below a threshold level, wherein at least one buffer is present in a buffer pool if the number of buffers falls below the threshold level.

16. The data processing system of claim 15, wherein the threshold level is a first threshold level and wherein the processor unit further executes the computer usable program code to provide the buffer to the transport layer if the number of buffers in the buffer pool exceeds a second threshold level after the number of buffers falls below the first threshold level.

17. The data processing system of claim 16 wherein the processor unit further executes the computer usable program code to provide the buffer to the transport layer if the number of buffers in the buffer pool exceeds the first threshold level.

18. The data processing system of claim 15 wherein the processor unit further executes the computer usable program code to receive the request from a transport control protocol stack in a control layer for the buffer.

19. The data processing system of claim 15 wherein the processor unit further executes the computer usable program code to supply the transport layer a particular buffer that is not in the pool of buffers.

20. The data processing system of claim 19, wherein the particular buffer is a system buffer.
